(19) United States
(12) Patent Application Publication
(10) Pub. No.: US 2006/0238505 A1
(43) Pub. Date: Oct. 26, 2006

(54) Control device for browsing and selecting an item in a list

(75) Inventors: Pentti Ahlgren, Helsinki (FI); Jari Nousiainen, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/323,466

(22) Filed: Dec. 30, 2005

Related U.S. Application Data
(63) Continuation-in-part of application No. 11/028,954, filed on Jan. 3, 2005.

(51) Int. Cl. G09G 5/08

(52) U.S. Cl. 345/161

(57) ABSTRACT

The invention relates to a control device for browsing and selecting an item in a list. Especially the invention relates to a joystick type control device to be used in portable electronic devices, such as mobile phones and laptops. The control device comprises a stick means, which is coupled with a joint to the control device. Further the control device comprises at least one switch and at least one sensor, where the switch is adapted to make contact and generate a digital-type output signal when the stick means is deflected from its rest position in a direction. The sensor is adapted to generate an analog output signal when the stick means is deflected in from its rest position to a direction.

### CROSS-REFERENCE TO RELATED APPLICATIONS

This application is a continuation-in-part of copending application Ser. No. 11/028,954 filed on Jan. 3, 2005 and claims benefit to domestic priority under 35 U.S.C. §120.

### TECHNICAL FIELD OF THE INVENTION

The invention relates to a control device for browsing and selecting an item in a list.

### BACKGROUND OF THE INVENTION

Different kinds of control devices are know from prior art for browsing and selecting an item in a list. Apart from mouse devices, one of the most popular is joystick, which has been used to be a computer peripheral or general control device consisting of a hand held stick that pivots about one end and transmits its angle in two or three dimensions to a computer. Most joysticks are two-dimensional, having two axes of movement, just like a mouse, but three-dimensional joysticks do also exist. Joysticks are often used for controlling machines, such as elevators, cranes, trucks and airplanes, but also for controlling games and browsing and selecting an item in a list, such as in portable electronic devices.

There are generally two kinds of joysticks, namely digital and analog joysticks. The first one can be implemented with on/off-switches, whereas the analog joystick can be implemented with potentiometers, strain gauges, and capacitive sensors, for example. An output of the digital joystick is 1/0, or on/off-type (pulse shaped signal), but with the analog joystick magnitude of an output signal, such as voltage or electric current, can be varied from 0% to 100% per direction (wave shaped signal) depending on the deflection of the stick from its rest position.

Generally digital joysticks, which have been used widely in multimedia phones as an input device, are good in exact positioning, for example, when selecting an item in a list, whereas a browsing a long list, for example, is better and faster done with an analogue device such as analog joystick. For final selection a digital device, such as digital joystick, is better again. With an analogue device a user can accelerate a browsing, for instance, by deflecting the analog joystick further from its rest position, and thus browse a long list within a reasonable time, whereas the digital joystick is more accurate for selecting special items in a list without needing a special dexterity.

Now there will be a requirement of a control device, which can be used at least for quicker browsing as well as more accurate selecting at a same mobile device.

### SUMMARY OF THE INVENTION

The object of the invention is to provide a control device, which can be used at least for quicker browsing as well as more accurate selecting at the same mobile device, such as a mobile phone.

The objects of the invention are fulfilled with a control device, where digital and analogue features of joysticks are combined in a joystick-type control device. This joystick has both digital and analogue modes available at the same time and at the same mobile device.

The first aspect of the present invention relates to a control device for browsing and selecting an item in a list, wherein the control device comprises a stick means, which is coupled with the control device, the control device further comprising at least one switch and at least one sensor, where the switch is adapted to make contact and generate a digital-type output signal when the stick means is deflected from its rest position in a direction, and after the contact is made the sensor is adapted to generate an analog output signal when the stick means is further deflected in the same direction from its rest position as when the digital-type output signal was generated.

The second aspect of the present invention relates to a control device for browsing and selecting an item in a list, wherein the control device comprises a stick means, at least one switch and at least one sensor, wherein
a) at least a body related to said stick means is adapted to move essentially in a vertical direction (up-down) when said stick means is deflected from its rest position, said body causing the switch to make contact and generate a digital-type output signal, and
b) the sensor is adapted to generate an analog output signal when the stick means is deflected essentially in a horizontal direction (left-right-forward-backward) in the horizontal plane from its rest position, where the horizontal direction is essentially perpendicular to said vertical direction.

In addition the present invention relates also to a computer program product having a computer program stored on a readable medium, the computer program product adapted to read output signals of a control device for browsing and selecting an item in a list when the computer program is run on a computer, the control device comprising a stick means, which is coupled with the control device, the control device further comprising at least one switch and at least one sensor, where the switch is adapted to make contact and generate a digital-type output signal when the stick means is deflected from its rest position in a direction, and the sensor is adapted to generate an analog output signal when the stick means is further deflected in the same direction from its rest position as when the digital-type output signal was generated, wherein the computer program is further adapted to read the output signals of the control device in such a way, that the measurement of the deflection of the stick means from its rest position causing the analog signal is measured after the contact has been made.

Furthermore the present invention relates also to a computer program product having a computer program stored on a readable medium, the computer program product adapted to read output signals of a control device for browsing and selecting an item in a list when the computer program is run on a computer, the control device comprising a stick means, at least one switch and at least one sensor, wherein
a) at least a body related to said stick means is adapted to move essentially in a vertical direction (up-down) when said stick means is deflected from its rest position, said body causing the switch to make contact and generate a digital-type output signal, and
b) the sensor is adapted to generate an analog output signal when the stick means is deflected essentially in a horizontal direction (left-right-forward-backward) in the horizontal plane from its rest position, where the horizontal direction is essentially perpendicular to said vertical direction.

According to an embodiment of the present invention digital and analogue features are combined in the joystick of the invention in a manner, where the digital features are achieved when the stick means of the joystick is pressed from its rest position in a certain amount in a certain direction (to x-y direction, for example) and the analog features are achieved when the stick means of the joystick is pressed a little more in the same direction.

In a further embodiment of the invention the joystick can be implemented with switches generating on/off-type output signals and further with a means sensing force or angle with which the stick means of the joystick is deflected.

According to a second further embodiment of the invention the switches are based on domes and dome pressers, advantageously on the dome and the respective dome presser, in such a way, that when a user presses the stick means from the rest position the dome presser coupled fixedly with the stick makes contact with the dome and on/off-type output signal is generated. The dome pressers are advantageously like a soft dome presser, whereas the domes are like digital dome switches.

According to a third further embodiment of the invention analog features can be achieved when the user, after pressing the dome, presses the stick means a little more in the same direction, whereupon the analogue measurement of the press force is started. The measured force can be used to accelerate or brake the list browsing by controlling the cursor speed. Force measurement can be realised advantageously with strain gauge sensors or capacitive sensing implemented in the stick construction or under the domes. It is however clear for a skilled person that the force measurement, or the measurement of the deflection (angle) of the stick means from its rest position can also be realised with other means known from prior art, such as potentiometers.

According to a fourth further embodiment of the invention the joystick of the invention can be implemented so that under the joystick shaft there is an analog area that is used for analog movement and at the edge of the area there are domes that are used to detect digital movement.

According to a fifth further embodiment of the invention the joystick of the invention is implemented so that the domes and dome pressers are arranged near the shaft, whereupon the dome and dome presser make contact and cause a digital feature advantageously before the deflection measurement and analog features, when the stick means is deflected from the rest position.

In the embodiments mentioned above the domes and dome pressers are adapted to make contact first when the stick means is pressed, whereupon digital features are achieved, and after the dome contact the deflection of the stick means from its rest position is started to measure, whereupon the analog features are achieved. It should be noted that the placing of the domes in relation to the analog area (area, where the deflection of the stick means from the rest position is measured) is fairly free according to the spirit of the invention. The domes can be adapted to being pressed first when the stick means is deflected from the rest position and just after this the deflection or force caused by the stick means deflection is adapted to being measured. In other words the digital features are adapted to being happened first and secondly the analog features in the embodiments mentioned above.

However, according to a sixth further embodiment of the invention analog features can also be adapted to be measured at first, so when the user starts to press the stick means in a direction and before pressing the dome (before digital-type output), whereafter pressing little more in the same direction the dome will be pressed and digital-type output generated. When the stick is pressed further to the same direction, the analog features are again measured.

According to a seventh further embodiment of the invention a computer program, such as a programming interface (API), is further adapted to read output signals from the joystick of the invention in a manner, where the measurement of the deflection or force caused by the deflection of the stick means of the joystick from its rest position is measured after the digital contact has been made by at least one dome. Now it should be noted that when the deflection or force is started to measure and the analog features will be generated the digital contact is still sustained.

According to an eighth further embodiment of the invention the sensor is adapted to generate an analog output signal also at first, when the stick means is started to deflect from its rest position in a direction and before the switch is adapted to make contact and generate a digital-type output signal, whereupon the computer program product is also adapted to read the output signals of the control device in such a way, that the measurement of the deflection of the stick means from its rest position causing the analog signal is measured before the switch is adapted to make contact and generate a digital-type output signal.

In addition, according to a further embodiment of the invention analog features can be achieved when the stick means is deflected essentially in a horizontal direction (left-right-forward-backward or intermediate directions) in a horizontal plane from its rest position, where the horizontal plane is essentially perpendicular to the vertical (up-down) direction. The horizontal action is based on a real tangible move of a finger to make the movement more understandable and usable for the user. The magnitude of the analog signal is proportional to the deflection from the rest position of the stick means. In this embodiment pure analog signal can be achieved without any digital-type output signals. In this embodiment the computer program product is advantageously adapted to read the output signals of the control device in such a way that the measurement of the deflection of the stick means from its rest position in the horizontal plane causing the analog signal is measured, when the stick means is deflected in the horizontal plane from its rest position. For sensing the horizontal move there can be used capacitive, inductive, magnetic field based, optical or force recognition technologies. Moreover the stick means should be returned to the initial central (rest) position after user action. Thus there should be either a spring or magnetic field based force returning it to the centre.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The embodiments of the invention will be described by way of examples only, in greater detail with reference the accompanying drawings, in which:

FIGS. 1A-C illustrate a first example of a joystick according to an embodiment of the invention, where the joystick is in rest (A), digital (B) and analogue (C) positions,

FIGS. 2A-C illustrate a second example of a joystick according to an embodiment of the invention, where the joystick is in rest (A), digital (B) and analogue (C) positions,

FIG. 3 illustrates an exploded view of a third example of a joystick construction according to an embodiment of the invention,

FIGS. 3A-C illustrate a third example of a joystick according to an embodiment of the invention, where the joystick is in rest (A), digital (B) and analogue (C) positions

FIG. 4 illustrates an example of a chart of the moving area of the stick means head according to an embodiment of the invention,

FIG. 5 illustrates an example of a block diagram of the computer program for reading output signals from the joystick according to an embodiment of the invention,

FIG. 6 illustrates a side view of yet another example of a joystick construction according to an embodiment of the invention,

FIG. 7 illustrates an exploded view of yet another example of a joystick construction according to an embodiment of the invention,

FIGS. 8A-D illustrate yet another example of a joystick according to an embodiment of the invention, where the joystick is in different operational positions, and

FIGS. 9A-D illustrate a further example of a joystick according to an advantageous embodiment of the invention, where the joystick is in rest (A), digital (B) and analogue (C) positions.

### DETAILED DESCRIPTION

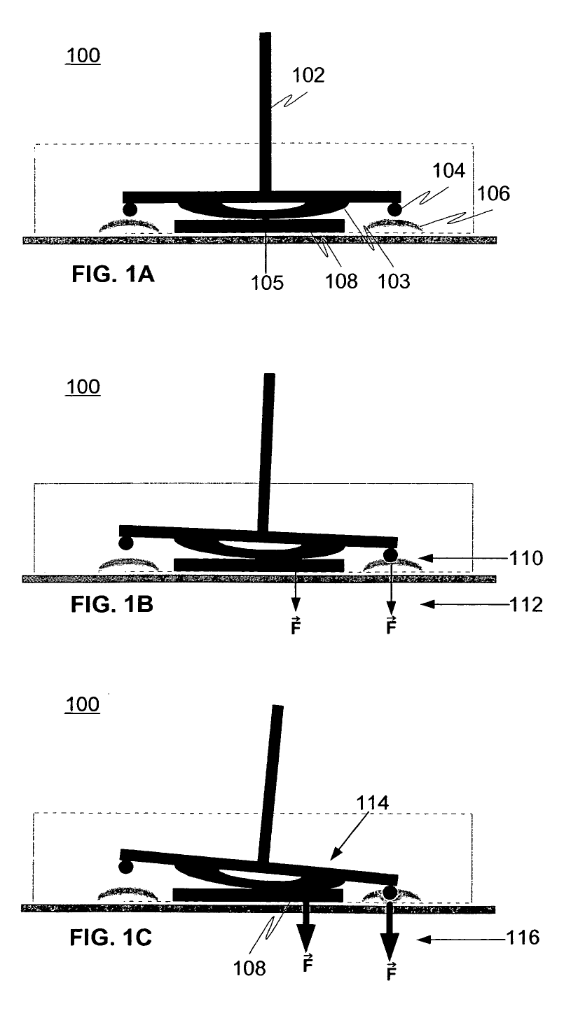

FIG. 1A illustrates a first example of a joystick 100 according to an embodiment of the invention, where the joystick is in rest position. The joystick comprises a stick means 102 such as a stick or pole, by which a user can control an operation of the joystick. The joystick 100 according to an embodiment of the invention further comprises a dome presser 104, which is advantageously fixedly coupled with the stick 102, and a dome 106, which is fixedly arranged to a base of the joystick 100. Typically the joystick comprises four dome pressers 104 and also four domes 106, one dome for each dome presser, respectively. The dome 106 is used to generate on/off-type digital output, when it is pressed.

In addition the joystick 100 comprises an analog sensor 108 for measuring the deflection or force caused by the deflection of the stick means of the joystick from its rest position. The analog sensor can be one of the following: strain gauge sensor, capacitive sensing sensor or potentiometer depending whether the force induced by the base 103 of the stick means 102 to the analog sensor 108 or the deflection angle of the stick means 102 is measured. The analog sensor 108 is used to generate essentially continuous-type analog output, which can vary from 0% to 100%, for example. The measured force or deflection angle of the stick means can then be used to accelerate or brake the list browsing by controlling the cursor speed, for instance.

FIG. 1B illustrates the first example of the joystick 100 according to an advantageous embodiment of the invention, where the joystick 100 is in digital position. In the joystick construction according to the invention the dome pressers 104 and domes 106 are advantageously adapted to make contact 110 when the stick means 102 of the joystick 100 is pressed sufficiently in a direction, whereupon a digital feature is achieved and on/off-type output signal is generated. When making the contact 110 the dome can close an electric circuit, for example.

In this position, where the dome contact is only just made, force (F) 112 applied to the analog sensor is quite small but based on the dome structure the user can feel clear tactile feedback experience. The dome is advantageously adapted to make clear tactile feedback, when it is pressed enough. According to a further embodiment of the invention the joystick construction, or a special program, such as an Application Programming Interface (API), can be adapted to start measuring the applied force or a deflection angle only after the dome contact 110 has first been made, whereupon the order of digital and analog output can be achieved.

FIG. 1C illustrates the first example of the joystick 100 according to an embodiment of the invention, where the joystick 100 is in analog position, and the analog sensor 108 measures 114 the deflection angle or force applied by the stick means. An analog position, features and outputs are achieved, when the stick means is pressed a little more in the same direction than at first from the rest position, whereupon magnitude of force (F) 116 will increase substantially when compared to the situation illustrated in FIG. 1B. The more the stick means is pressed or deflected from the rest position over the digital position, the greater force is applied to the analog sensor and also the value of the analog output comes up to 100%, for example.

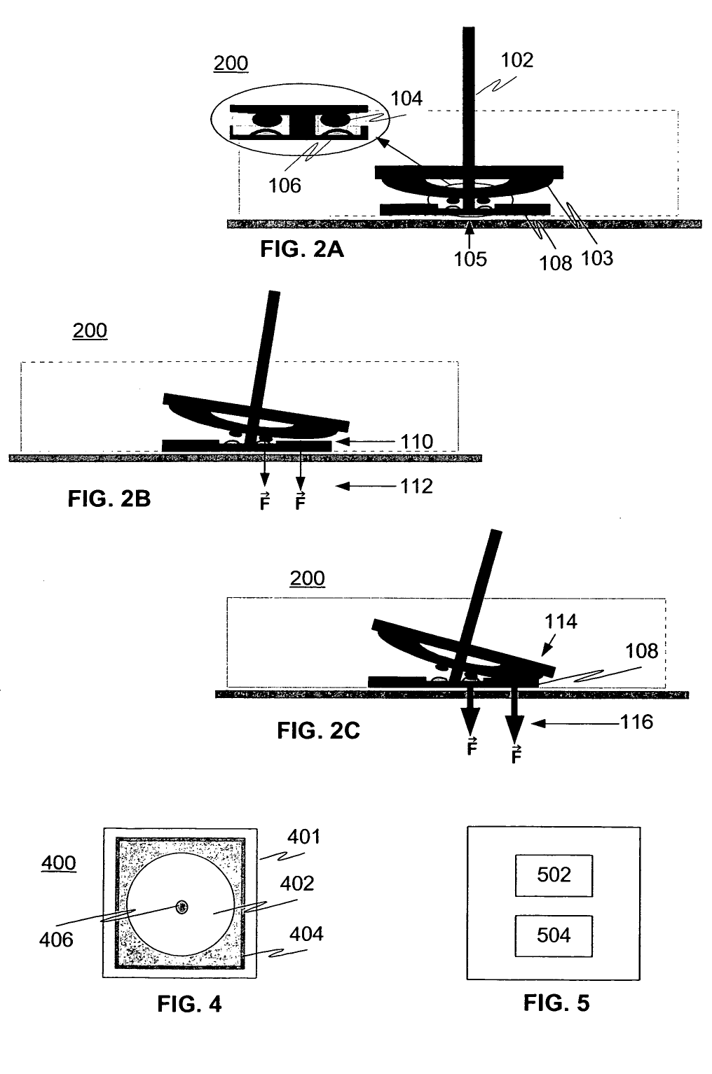

FIG. 2A illustrates a second example of a joystick 200 according to an embodiment of the invention, where the joystick is in a rest position. The construction of the joystick 200 is otherwise similar to the construction of the joystick 100 illustrated in FIG. 1A-C, but the dome pressers and domes 104, 106 are located in the joystick 200 in a different place than in the joystick 100, namely next to the joint 105 of the stick means 102 of the joystick 200. However, the operational principle, and especially the digital and analog output signals of the joystick 200 can be similar with the joystick 100 illustrated in FIG. 1A-C.

FIG. 2B illustrates the second example of a joystick 200 according to an embodiment of the invention, where the joystick 200 is in a digital position. Also with the second exemplary joystick construction 200 of the invention, the dome pressers 104 and domes 106 are advantageously first adapted to make contact 110 when the stick means 102 of the joystick 100 is pressed sufficiently in a direction, whereupon a digital feature is achieved and on/off-type output signal is generated. When making the contact 110 the dome can close an electric circuit, for example.

In this position, where the dome contact is only just made, force (F) 112 applied to the analog sensor is quite small or insignificant, and it can be ignored. However, based on the dome structure the user can feel clear tactile feedback experience, because the dome is advantageously adapted to make clear tactile feedback, when it is pressed enough. According to a further embodiment of the invention the joystick construction, or a special program, such as an Application Programming Interface (API), can be adapted to start measuring the applied force or deflection angle only after the dome contact 110 has first been made, whereupon the order of digital and analog output can be achieved.

FIG. 2C illustrates the second example of a joystick 200 according to an embodiment of the invention, where the joystick 200 is in an analog position, and the analog sensor 108 measures 114 the deflection angle or force applied of the stick means. Also with the second exemplary joystick construction 200 of the invention, an analog position, features and outputs are achieved, when the stick means is pressed a little more in the same direction than at first from the rest position, whereupon magnitude of force (F) 116 will increase substantially when compared in the situation illustrated in FIG. 2B. The more the stick means is pressed or deflected from the rest position over the digital position, the greater force is applied to the analog sensor and also the value of the analog output comes up to 100%, for example.

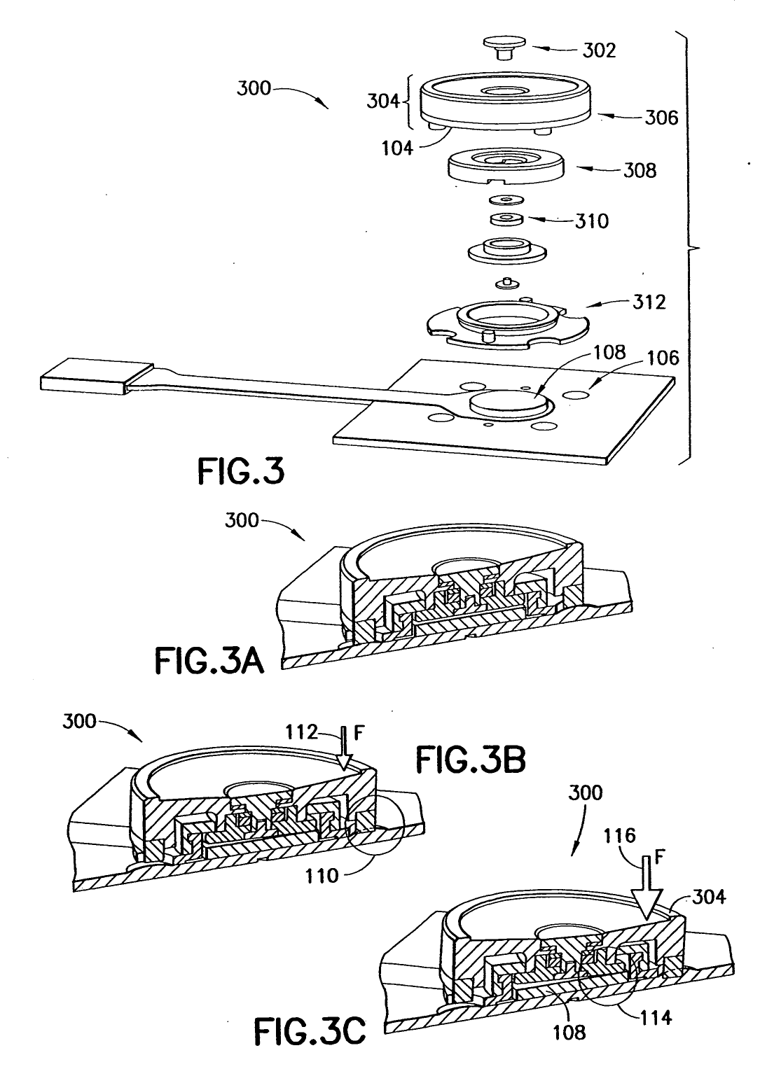

FIG. 3 illustrates an exploded view of a third example of a joystick construction 300 according to an embodiment of the invention, where a user can control an operation of the joystick 300 by a stick means 304. The joystick 300 according to the third embodiment of the invention also comprises a dome presser 104, which is advantageously fixedly coupled with the stick means 304, and a dome 106, which is fixedly arranged to a base of the joystick 300. The stick means 304 with the dome presser 104 is advantageously composed of a multi-material joystick button, where the domes pressers 104 are advantageously implemented by an elastic dome button ring 306. In addition the joystick 300 comprises an analog sensor 108 for measuring the deflection or force caused by the deflection of the stick means 304 of the joystick from its rest position.

Furthermore the joystick 300 comprises a select button 302, top cover 308 covering an elastic ring 310 for the select button 302. The elastic ring works like return spring for the select button 302. Further the joystick 300 comprises a bottom cover 312.

FIG. 3A illustrates the third example of a joystick 300 according to an embodiment of the invention, where the joystick is in rest position.

FIG. 3B illustrates the third example of a joystick 300 according to an embodiment of the invention, where the joystick 300 is in digital position. Also with the third example of a joystick construction 300 of the invention the dome presser 104 and dome 106 are advantageously first adapted to make contact 110 when the stick means 304 of the joystick 300 is pressed sufficiently in a direction, whereupon a digital feature is achieved and on/off-type output signal is generated. When making the contact 110 the dome can close an electric circuit, for example.

In this position, where the dome contact is only just made, force (F) 112 applied to the analog sensor is quite small or insignificant, and can is ignored. However, based on the dome structure the user can feel clear tactile feedback experience, because the dome is advantageously adapted to make clear tactile feedback, when it is pressed enough. According to a further embodiment of the invention the joystick construction, or a special program, such as an Application Programming Interface (API), can be adapted to start measuring the applied force or deflection angle only after the dome contact 110 has first been made, whereupon the order of digital and analog output can be achieved.

FIG. 3C illustrates the third example of a joystick 300 according to an embodiment of the invention, where the joystick 300 is in analog position, and the analog sensor 108 measures 114 the deflection angle or force applied of the stick means 304. Also with the third example of a joystick construction 300 of the invention, an analog position, features and outputs are achieved, when the stick means 304 is pressed a little more in the same direction than at first from the rest position, whereupon magnitude of force (F) 116 will increase substantially when compared to the situation illustrated in FIG. 3B. The more the stick means 304 is pressed or deflected from the rest position over the digital position, the greater force is applied to the analog sensor and also the value of the analog output comes up to 100%, for example.

The force measurement, for example, in the joystick construction 100, 200, 300 according to the invention can be realised advantageously with different analog sensors mentioned above. The analog sensors 108 can be placed according to an embodiment of the invention under the stick means 102, 304, or to be exact, between the dome 106 and the joint 105 of the stick means 102 in the first embodiment illustrated in FIGS. 1A-C, and according to the second embodiment to outer side of the dome 106 (when seen from the joint 105 of the stick means 102) as illustrated in FIGS. 2A-C. Alternatively the analog sensors 108 can be placed according to another embodiment of the invention under the domes or dome pressers, advantageously under the domes 106, whereupon force applied on the dome 106 when the stick means is deflected from the rest position is started to measure and the analog output signal is generated only after the domes 104, 106 have first made the contact and the digital output signal is generated.

With the construction, where the analog sensors 108 are placed under the domes 106, very compact joystick construction can be achieved, especially if the joystick construction 200 illustrated in FIG. 2A-C is used.

In further embodiments, dome pressers 104 and/or domes 106 in the joystick constructions illustrated above are advantageously adapted to make clear feedback, when the contact is made and the digital output signal is generated, like with the typical digital joysticks. This can be achieved by choosing appropriate materials used for preparing the domes 104, 106.

However it should be noted relating to FIGS. 1A-C and 3A-C that according to the sixth embodiment of the invention the analog features can also be adapted to be measured at first, so when the user starts to press the stick means in a direction from the rest position and before pressing the dome (before digital-type output, FIGS. 1B, 3B), whereafter pressing a little more in the same direction the dome will be pressed and digital-type output generated (FIGS. 1B, 3B). When the stick is pressed further in the same direction, the analog features are again measured (FIGS. 1C, 3C).

FIG. 4 illustrates an example of a chart 400 of the moving area 401 of a head of the stick means according to an embodiment of the invention. An analog area 402 is used for analog movement and an analog output signal will be generated 0 to 100% per direction when stick movements is in the inner area 402. At the edge 404 of the moving area 401 there are domes that are used to detect digital movement. A line 404 illustrates a dome click zone of a four domes stick version. The inner area 406 in the middle of the moving area 401 represents the zero or rest position of the stick of the joystick, when the digital output signal is advantageously 0 as well as also the analog output signal, or to be exact, the analog output signal is essentially 0%.

FIG. 5 illustrates an example of a block diagram of the computer program product 500, which is adapted to read output signals from the joystick according to an embodiment of the invention in such a way that the measurement of the deflection or force caused by the deflection of the stick means of the joystick from its rest position is started to be measured only after the digital contact has been made by at least one dome. Thus there is a first analyser code component 502 in the computer program product, which is adapted to observe, when the computer program is run on a computer, whether the a contact is made by the domes and the digital output signal is generated.

In addition there is a second analyser code component 504 in the computer program product, which is adapted to observe, when the program is run on a computer, whether the domes have made the contact and the stick means of the joystick is further deflected in the same direction, whereupon the deflection of the stick means is started to measure. Further the second analyser code component 504 is adapted to start measuring the magnitude of the analog output signal generated when the stick means is deflected to the analog area. Now it should be noted that when the deflection or force is started to measure and the analog features will be generated, the digital contact is still sustained.

However, according to the sixth embodiment of the invention the first analyser code component 502 in the computer program product can be ignored and the second analyser code component 504 is adapted to measure the magnitude of the analog output signal continuously when the program is run on a computer. According to sixth embodiment of the invention the analog features can thus be measured at first, so when the user starts to press the stick means in a direction from the rest position and before pressing the dome (before digital-type output, FIGS. 1B, 3B), whereafter pressing a little more in the same direction the dome will be pressed and digital-type output generated (FIGS. 1B, 3B). When the stick is pressed further to the same direction, the analog features are again measured (FIGS. 1C, 3C).

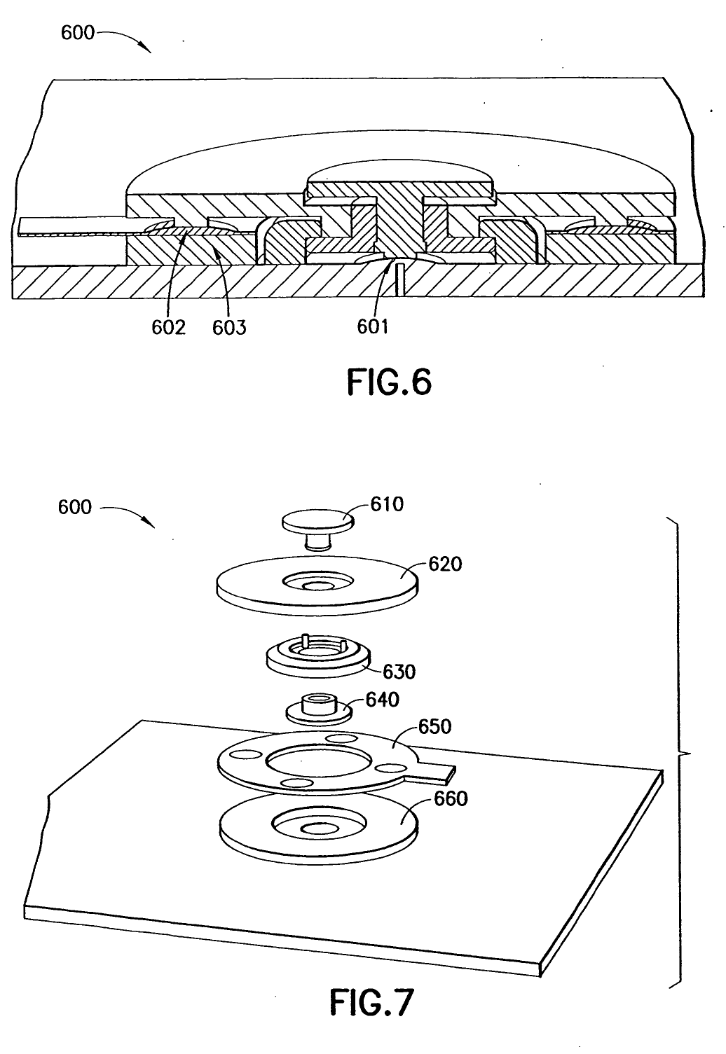

FIG. 6 illustrates a side view of yet another example of a joystick construction 600 according to an embodiment of the invention. The further embodiment of FIG. 6 comprises a selection keydome 601 for enabling the movement of the stick means of the joystick. Furthermore the joystick 600 comprises a keydome 602 for digital switch detection means. The keydome 602 can engage and accordingly convey the digital signal for the detection of the motion of the stick means. Yet furthermore the joystick (600) comprises an analog sensor 603. The analog sensor 603 can engage and convey the analog signal for the detection of the motion of the stick means. Also the analog means can establish more details of the movement of the stick means. In the further embodiment of FIG. 6 the analog sensor 603, for example the analog detection means, and the keydome 602, for example for the digital detection means, can be situation one upon the other. For example, the digital detection means are situated on the analog detection means. This kind of construction and design can save space and make the joystick more compact.

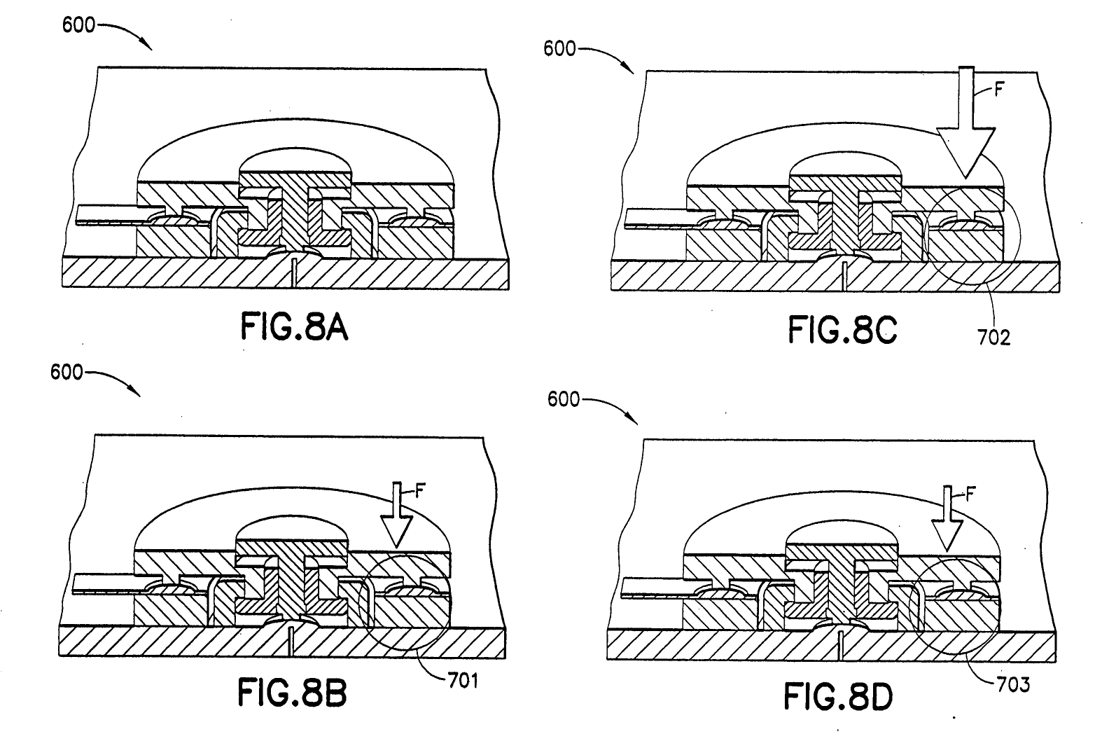

In the further embodiments relating to the FIG. 6 and furthermore to FIGS. 7 and 8, the digital detection means, e.g. a keydome, and the analog detection means, i.e. the analog sensor, can be located one upon the other. Therefore there can be different kind of forces actuating on the digital on each of them. Smaller pressing force actuates first the digital detection means, e.g. keydome to be pressed down and makes the contact. Bigger force actuates on the analog detection means, e.g. the analog press sensor creating an analog signal that can be used for example for faster lost browsing or cursor movement.

Referring now to FIG. 7, there is being illustrated an exploded view of yet another example of a joystick construction 600 according to an embodiment of the invention. For example the further embodiment of FIG. 6 can be illustrated in the exploded view of FIG. 7. The joystick 600 of the further embodiment of FIG. 7 comprises a select means 610. The select means 610 can be used for interfacing with, for example a finger of the user. The joystick 600 comprises also a joystick hat 620. The joystick hat 620 can cover the joystick 600. Furthermore it can provide a protective upper housing for the joystick. Also it can provide some limitation for the movement of the select means 610 thereby establishing the mechanical limitation for the movement of the select means 610. The joystick also has a base 630 for creating mechanical support and housing means for the joystick structure. Furthermore a lock 640 is provided in the joystick 600. The lock 640 can establish a locking means for maintaining the select means 610 locked in the joystick 600. The lock 640 attaches the base 630 to the lock 640. Furthermore the lock 640 supports the joystick hat 620. The joystick 600 further comprises a dome flex 650 containing, for example four different digital detection means such as four different keydomes. Furthermore the joystick 600 comprises the analog sensor 660 underneath the dome flex 650. Thereby the analog detection means can coincide with the digital detection means in the substantially same vertical plane.

FIGS. 8A-D illustrate yet another exemplary joystick 600 according to a further embodiment of the invention, where the joystick is in different operational positions. FIG. 8A depicts a zero position, when, the joystick is basically in the normal standby mode. FIG. 8B shows the movement so that when pressing or moving the select means 610 in a direction a small pressing force affects the digital detection means so that the keydome 602 for example can click or snap down to make an indication. This is highlighted in the area 701. In FIG. 8C the force increases and thereby actuates the analog detection means. This is indicated in the area 702. For example, the bigger force actuates on the analog sensor 603 creating an analog signal that can be used. For example it indicates faster list browsing or cursor movement. In the FIG. 8D less force is being conveyed to the area 703. Thereby the analog detection means is diminished to the digital sensing so that, for example, final cursor positioning can be established with the digital ‘clicking’.

Furthermore it should be noted that the domes applied to make digital output signals can be placed in different locations. Moreover analog sensors for measuring deflection or force caused by the stick means deflection can be placed either on a bottom base of the joystick, for example, or under the domes, especially under said second domes. Furthermore digital-type output signal can also be generated without domes in an embodiment, where the joystick is adapted to generate digital-type output signal when the magnitude of the analog output signal exceeds a certain limit or threshold.

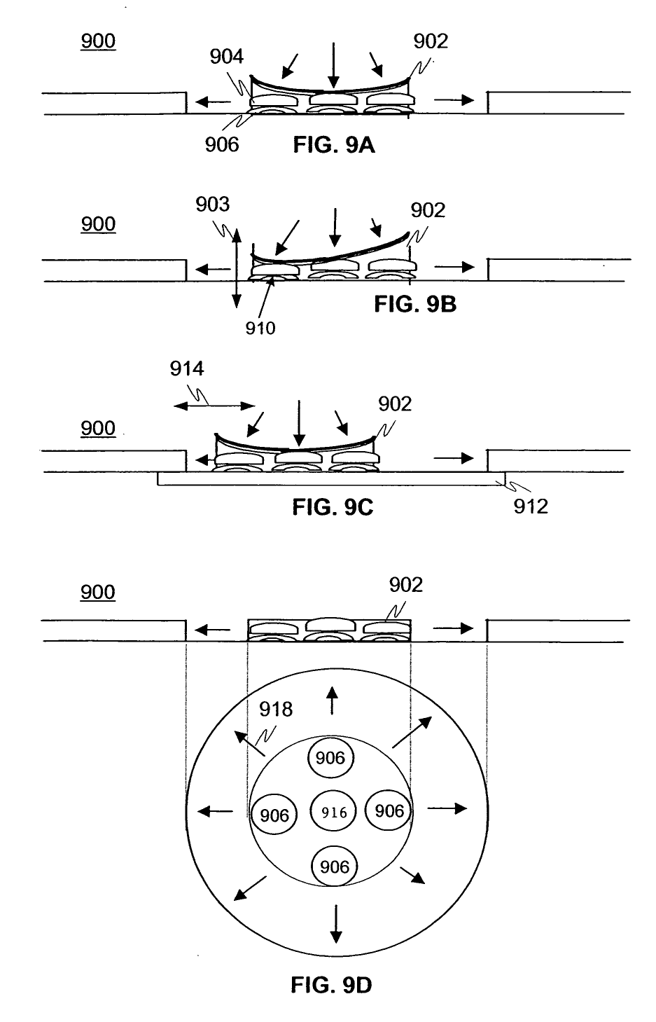

In addition, FIGS. 9A-D illustrate a further example of control means, in other words joystick 900 according to an advantageous embodiment of the invention, where the digital feature acts up-down, but the analog feature acts in horizontal direction. The horizontal action is based on a real tangible move of a thumb or other finger, so it is more understandable and usable for the user. The joystick 900 is in rest position in FIG. 9A.

FIG. 9B illustrates the joystick 900 in a digital position, where the stick means 902 is deflected from its rest position so that at least a body 904 (which can be implemented by a dome presser illustrated above) related to said stick means 902 is adapted to move essentially in a vertical direction 903 (up-down) in relation to a dome. When said stick means 902 is deflected at least one dome 906 and a corresponding dome presser 904 is adapted to make contact 910 and generate a digital-type output signal, whereupon a digital feature is achieved. When making the contact 910 the dome can close an electric circuit, for example.

FIG. 9C illustrates the joystick 900 in an analog position, where the analog sensor 912 measures the deflection of the stick means 902. The sensor 912 is adapted to generate an analog output signal when the stick means 902 is deflected essentially in a horizontal direction 914 (left in FIG. 9C, but it can also be deflected right, forward, backward or in a somewhat intermediate direction, such as illustrated in FIG. 9D) in the horizontal plane from its rest position. The force measurement, for example, in the joystick construction 900, according to the invention can be realised advantageously with different analog sensors mentioned above.

FIG. 9D illustrates a schematic block diagram of the joystick 900 comprising domes 906 used for the digital direction and one dome 916 for the selection. Also intermediate direction 918 can be selected with digital domes if two adjacent domes 906 are pressed simultaneously or at least essentially simultaneously. It should be noted that the stick means can be deflected also in intermediate directions 918 in the horizontal plane, whereupon the analog signal relating to the intermediate directions 918 is generated.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

What is claimed is:

1. A control device for browsing and selecting an item in a list, wherein the control device comprises a stick means, which is coupled with the control device, the control device further comprising at least one switch and at least one sensor, where the switch is adapted to make contact and generate a digital-type output signal when the stick means is deflected from its rest position in a direction, and after the contact is made the sensor is adapted to generate an analog output signal when the stick means is further deflected in the same direction from its rest position as when the digital-type output signal was generated.

2. The control device according to claim 1, wherein the sensor is further adapted to generate an analog output signal at first, when the stick means is started to deflect from its rest position in a direction and before the switch is adapted to make contact and generate a digital-type output signal.

3. The control device according to claim 1, wherein the switch is implemented with a dome presser and dome, the dome presser being fixedly coupled with the stick means, and the dome presser and respective dome are adapted to make contact and generate a digital output signal when the stick means is deflected from the rest position.

4. The control device according to claim 3, wherein the dome presser is a soft dome presser, and where the dome presser and/or dome is adapted to make clear feedback, when the contact is made between the dome presser and domes and the digital output signal is generated.

5. The control device according to claim 1, wherein the magnitude of the analog signal is proportional to the deflection angle of the stick means.

6. The control device according to claim 1, wherein the magnitude of the analog signal is proportional to the force applied by the stick means to the sensor.

7. The control device according to claim 1, wherein the speed of the browsing of the list is proportional to the magnitude of the analog output signal.

8. The control device according to claim 1, wherein the sensor adapted for generating an analog output signal is at least one of the following sensor: strain gauge sensor, capacitive sensing sensor, inductive sensor, magnetic field based sensor, optical sensor and/or potentiometer.

9. The control device according to claim 1, wherein the sensor adapted for generating an analog output signal is located next to a joint of the stick means and the switch adapted for generating a digital output signal is located peripheral of the control device.

10. The control device according to claim 1, wherein the switch adapted for generating a digital output signal is located next to a joint of the stick means and the sensor adapted for generating an analog output signal is located peripheral of the control device.

11. The control device according to claim 1, wherein the switch adapted for generating an digital output signal is located on a plane with the sensor adapted for generating an analog output signal.

12. The control device according to claim 11, wherein the plane is vertical with respect to the structure of the control device.

13. The control device according to claim 11, wherein the plane is horizontal with respect to the structure of the control device.

14. The control device according to claim 11, wherein the switch and the sensor are adapted to locate one upon the other.

15. The control device according to claim 3, wherein the sensor adapted for generating an analog output signal is located under the dome.

16. The control device according to claim 1, wherein the control device is a joystick type control device, which is adapted to being used in portable electronic devices, such as mobile phones and laptops.

17. A control device for browsing and selecting an item in a list, wherein the control device comprises a stick means, at least one switch and at least one sensor, wherein
a) at least a body related to said stick means is adapted to move essentially in a vertical direction when said stick means is deflected from its rest position, said body causing the switch to make contact and generate a digital-type output signal, and
b) the sensor is adapted to generate an analog output signal when the stick means is deflected essentially in a horizontal direction in the horizontal plane from its rest position, where the horizontal direction is essentially perpendicular to said vertical direction.

18. A computer program product having a computer program stored on a readable medium, the computer program product adapted to read output signals of a control device for browsing and selecting an item in a list when the computer program is run on a computer, the control device comprising a stick means, which is coupled with the control device, the control device further comprising at least one switch and at least one sensor, where the switch is adapted to make contact and generate a digital-type output signal when the stick means is deflected from its rest position in a direction, and the sensor is adapted to generate an analog output signal when the stick means is further deflected in the same direction from its rest position as when the digital-type output signal was generated, wherein the computer program product is further adapted to read the output signals of the control device in such a way, that the measurement of the deflection of the stick means from its rest position causing the analog signal is measured after the contact has been made.

19. A computer program product having a computer program stored on a readable medium, the computer program product adapted to read output signals of a control device for browsing and selecting an item in a list when the computer program is run on a computer, the control device comprises a stick means, at least one switch and at least one sensor, wherein
a) at least a body related to said stick means is adapted to move essentially in a vertical direction when said stick means is deflected from its rest position, said body causing the switch to make contact and generate a digital-type output signal, and
b) the sensor is adapted to generate an analog output signal when the stick means is deflected essentially in a horizontal direction in the horizontal plane from its rest position, where the horizontal direction is essentially perpendicular to said vertical direction.
